(19) United States
(12) Patent Application Publication
(10) Pub. No.: US 2006/0186272 A1
(43) Pub. Date: Aug. 24, 2006

(54) Radio controlled parachute pack

(76) Inventor: Michael Dean Roseman, Chesapeake, VA (US)

Correspondence Address: MICHAEL ROSEMAN, 809 MONTROSE CT., CHESAPEAKE, VA, 23320, US

(21) Appl. No.: 11/062,911

(22) Filed: Feb. 22, 2005

(51) Int. Cl. B64D 17/00

(52) U.S. Cl. 244/142

(57) ABSTRACT

(FIG. 1) Shows the Pack attached to a Man in a free fall state until the remote radio transmitter sends a signal to disengage the parachute deployment pin (5), opening the parachute door (6), releasing the parachute as seen in (FIG. 2). In (FIG. 3) the parachute is seen fully deployed. (FIG. 4) shows a cross sectional view of the radio compartment of the parachute pack. The right and left turn servo (E) is shown attached to the parachute control lines (A) and (B). When the remote radio transmitter signals to turn left the receiver (G) tells the servo (E) to pull down on control cable (A) causing a left turn to be executed. The right turn signal works in a similar way. When a flare signal is sent, receiver (G) tells the flair servo (F) to pull down on control cable (D). This pulls down on the right and left side of the Parachute simultaneously which decreases the rate of decent.

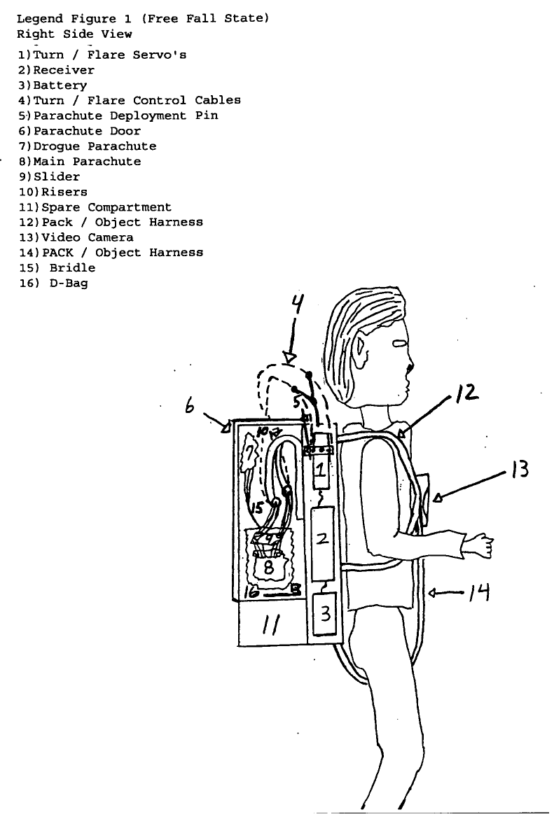

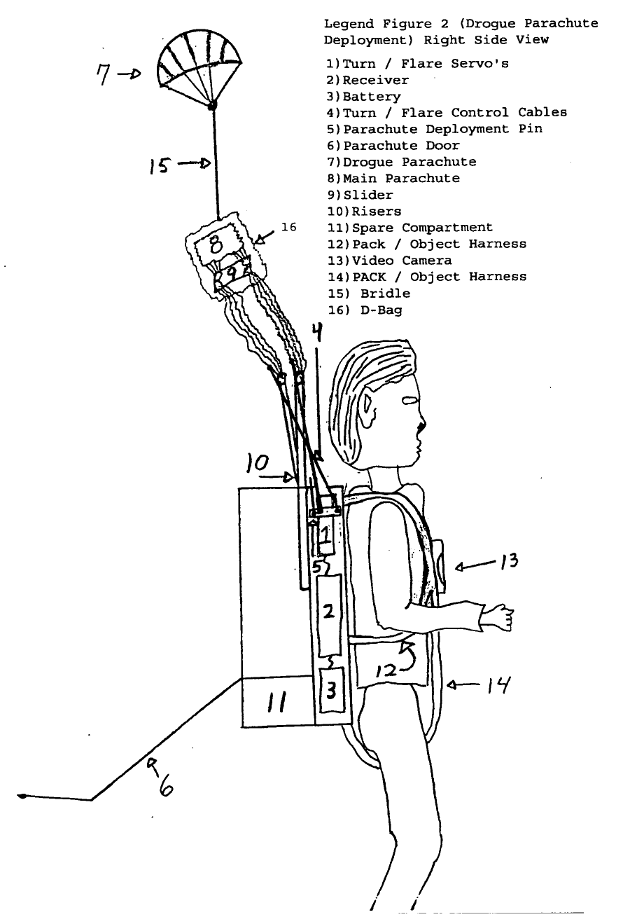

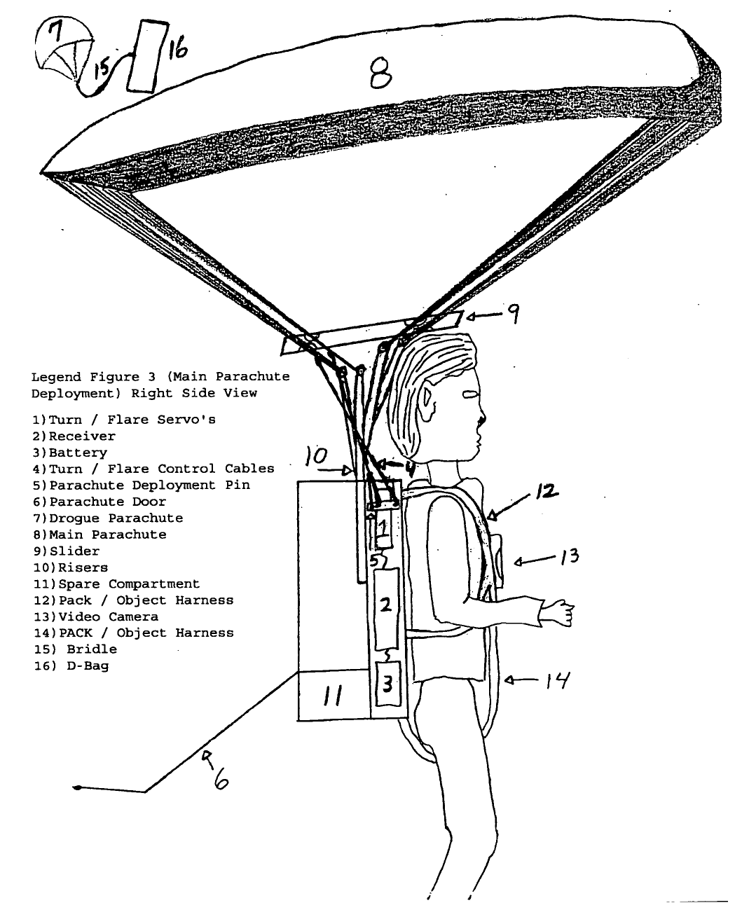

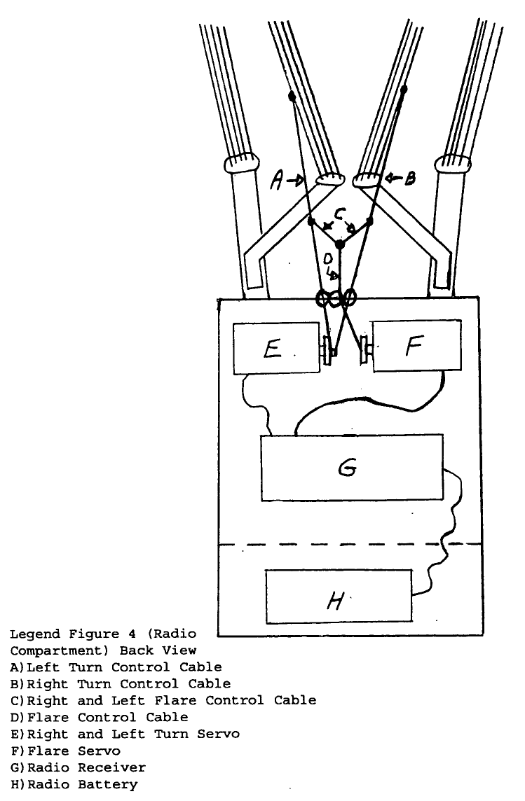

This Radio Controlled Parachute Pack will contain everything needed to deploy the Parachute as well as manipulate its airfoil during flight to control its descent rate and direction from a remote hand held radio transmitter. It is for this reason that it is desirable to use a Ram Air Parachute (See U.S. Pat. No. 3,285,546). The devices needed to accomplish this are a Ram Air Parachute, Radio Controlled Parachute Pack, Radio receiver, Servo/Servos, Battery pack, Control Cables, and a hand held Remote Radio Transmitter which is controlled by a Remote Operator. The pack can have a separate compartment for the radio equipment as well as a separate compartment for the packing and deployment of the Parachute. It should be noted that it doesn't have to be limited to just these two compartments. It may be beneficial to add additional compartments in the pack for housing other devices such as an on board Arial Camera or a smoke dispensing device for easy tracking of the Skydiver/Object while in flight.

The Servo/Servos will be firmly mounted in the radio compartment of the pack. When the hand held radio transmitter gives a right turn command to the Radio Receiver housed within the pack the receiver then makes the Turn Servo move to carry out the right turn command. The Turn Servo will pull down on a cable attached to right side of the Parachute. This will cause more drag on the right side of the parachute causing a right turn to be executed. It can be seen that just the opposite is true if a left turn is executed. It is desirable to pull on both the right and left side of the parachute to carry out what is known as a flare maneuver during a landing. This greatly reduces the speed and descent rate at the landing point. This is carried out by sending the flare command from the Remote Radio Transmitter. The Radio Receiver tells the Flare Servo to pull down on both the right and left turn control lines simultaneously. This causes more overall Drag on the parachute which slows its forward speed and makes for a softer and more controllable landing. The Radio Controlled Parachute Pack can be easily secured to the Skydiver or Object by use of Velcro straps or a Five Point Harness. Because the Radio Controlled Parachute Pack contains all of the necessary components need to control the direction of flight and the deployment of its Parachute remotely the skydiver or object attached to the Pack is basically along for the ride. This will allow the Radio Controller to drop a G.I. Joe, Barbie, and a Ken Doll or for that matter any other object(s) they desire as long as the weight of the object can be supported by the size of the Parachute. It truly becomes a universal Radio Controlled Parachute Pack.

What is claimed is:

1. The Radio Controlled Parachute Pack is a self-sufficient device that needs no assistance from the Skydiver or Object it is attached to while carrying out its task. This Radio Controlled Parachute Pack will contain everything needed to deploy the Parachute in a free fall as well as manipulate its airfoil during flight to control its descent rate and the direction of flight from a remote hand held radio transmitter. I.e. (Ram Air Parachute, Radio Controlled Parachute Pack, Radio Receiver, Servo/Servos, Battery Pack, Control Cables, and a hand held Remote Radio Transmitter). This makes it possible to drop and control any object as long as the weight of the object can be supported by the size of the Parachute.

2. This Radio Controlled Parachute Pack can contain one or more compartments for Parachute deployment and Radio equipment, etc. Additional compartments can be added to the Pack to accommodate devices such as an on board Arial camera for real time flight views or a smoke dispensing device for easy tracking of the Skydiver/Objects while in flight. Other devices and compartments can be added if beneficial to the functionality of the Radio Controlled Parachute Pack.

3. This Radio Controlled Parachute Pack isn't limited to any shape, size, or construction as long as it falls within the spirit of the invention.
